(19) United States
(12) Patent Application Publication
(10) Pub. No.: US 2006/0174775 A1
(43) Pub. Date: Aug. 10, 2006

(54) Apparatus and method for tracing cooking process

(76) Inventors: Mor. Yitzchak, Tivon (IL); Benjamin Geller, Akko (IL); Valentin Melnikov, Haifa (IL)

Correspondence Address: PEARL COHEN ZEDEK, LLP, 1500 BROADWAY 12TH FLOOR, NEW YORK, NY, 10036, US

(21) Appl. No.: 11/348,349

(22) Filed: Feb. 7, 2006

Related U.S. Application Data
(60) Provisional application No. 60/650,548, filed on Feb. 8, 2005.

(51) Int. Cl. A47J 37/06

(52) U.S. Cl. 99/358

(57) ABSTRACT

The method and apparatus of this invention enable tracing of cooking process in substantially any cooking oven or pot by inserting at least two electrodes into meat to be cooked, measuring sequentially values of at least one component or parameter of complex electrical impedance between the electrodes in certain frequency storing said values, comparing current momentary measured value to the initial measured value, and identifying meat readiness according to criteria of impedance based on said comparison.

### FIELD OF THE INVENTION

The present invention relates to an apparatus and method for tracing cooking process. In particular the invention is applicable to meat cooking.

### BACKGROUND OF THE INVENTION

In many circumstances it may be beneficial to trace cooking process automatically without intervention of a person. Such circumstances may occur when it is difficult to identify the readiness of the cooked meat or when the person who cooks wishes to utilize the cooking period with other activities. If the cooking is traced automatically and stops automatically when the food is ready for eating, or if an indicating means indicate when the food is ready, the person who cooks can do something else while the food cooks and may not be bothered with the cooking.

U.S. Pat. No. 4,554,440 to Lee, Jr. describes a food doneness control circuit which is connected with the supply circuit in an electric resistance cooker for quickly cooking food, such as ground meat, contactably interposed between electrodes. The control circuit senses the rate of change of the root mean square of current through the food as a function of its cooked condition and stops current to the electrodes in response to a predetermined rate of change of the root mean square value of the current through the food.

It may therefore be beneficial to have an apparatus and method for easily applying to a piece of meat that is to be cooked for monitoring the process of cooking and further for stopping the cooking when the piece of meat has reached a required level of readiness.

### SUMMARY OF THE INVENTION

The present invention provides an apparatus and method for tracing cooking process by measuring the electrical impedance of the cooked meat throughout the cooking process. The apparatus and method of the present invention cancel the necessity to check the meat readiness manually throughout the cooking process and enable to perform other activities while the meat cooks.

This invention provides a method comprising the steps of inserting two electrodes partially covered with insulating coating into the meat, measuring sequentially and storing at least one component or parameter of complex electrical impedance (module or real resistance or capacitive reactance or capacity) in certain frequency, identifying meat readiness according to criteria of impedance and providing readiness signal if said criteria are satisfied.

The criteria corresponding to the desired level of the meat readiness may be predefined.

Identifying the meat readiness may be done by calculating the ratio of each value of the impedance component to the initial measured value. In order to identify the meat readiness it is possible to check if said ratio has passed the extreme value and reached value corresponding to the meat readiness. The extreme value of the ratio may indicate the point in process where the meat starts to lose liquids. There may be certain meat conditions or types where said ratio may not reach extreme value. In these cases it is possible to check the meat readiness by checking if said ratio has reached certain value corresponding to the meat readiness.

This invention also provides an apparatus comprising a unit to measure sequentially at least one component or parameter of complex electrical impedance (module or real resistance or capacitive reactance or capacity) in certain frequency, at least two electrodes connected to said unit, said electrodes may be covered with insulating coating and may be inserted into the meat, and a unit to store the values of said impedance component and to identify meat readiness according to predefined criteria of impedance. A readiness signal may be produced if said criteria are satisfied.

The electrodes may be composed of groups of electrically coupled single electrodes. The tips of the electrodes may be shaped to be easily inserted into the meat, for example a sharp cone shape.

An indicating means may be connected to the output of the readiness signal. The indicating means may be visual or auditive.

Means to automatically stop the cooking when meat readiness is identified may be connected to the output of the readiness signal.

The apparatus may further comprise means to adjust said criteria of impedance to conform to various types of meat.

### BRIEF DESCRIPTION OF THE FIGURES

The present invention will be understood and appreciated more fully from the following detailed description taken in conjunction with the figures in which:

FIG. 1 is a schematic illustration of an embodiment of an apparatus according to the invention;

FIGS. 2A and 2B are schematic illustrations of series and parallel equivalent electrical circuits, respectively, of the electrical impedance between two electrodes inserted into a cooked meat (prior art); and

FIG. 3 is a schematic graph illustrating a preferable way of determining meat readiness according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

The method and apparatus of this invention enable tracing of the cooking process by measuring the impedance of the cooked meat throughout the cooking process.

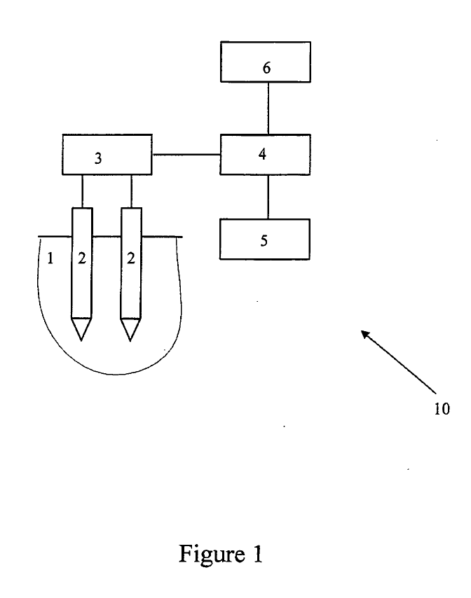

Attention is made to FIG. 1, which is a schematic illustration of an apparatus 10 according to some embodiments of the invention. Electrodes 2 may be inserted into meat 1. Electrodes 2 may be composed of at least two groups of at least one electrode in each group, said electrodes may be electrically coupled. Electrodes 2 may be partially covered (at least along an portion of the electrode inserted into the meat) with insulating coating (not shown), preferably with the tips of the electrodes uncovered. The tips of electrodes 2 may be shaped so as to easily be inserted into the meat, for example a sharp cone shape. Electrodes 2 can be connected to measurement unit 3 which may measure sequentially at least one component or parameter of complex electrical impedance (module or real resistance or capacitive complex reactance or capacity) between said electrodes in certain frequency. Measurement unit 3 may be connected to an input of calculating unit 4 for providing momentary values of impedance component, which may be stored in calculating unit 4. Calculating unit 4 may further identify meat readiness according to predefined criteria to which momentary impedance value may be compared. Calculating unit 4 may also produce readiness signal if said criteria are satisfied. Cooking control unit 5, which may be connected to the output of unit 4, may indicate when meat readiness is identified. Cooking control unit 5 may activate visual or audio indicator (not shown). Cooking control unit 5 may be able to stop the cooking automatically when meat readiness is identified. Adjusting unit 6 may contain means to adjust the criteria of impedance, and it may also be connected to an input of calculating unit 4.

Apparatus 10 may be used for the automatic detection of level of readiness of meat while being cooked, without needing to use a specialized cooking device. Apparatus 10 may be used with any cooking pot and may be cooked by any controllable cooking oven or heater.

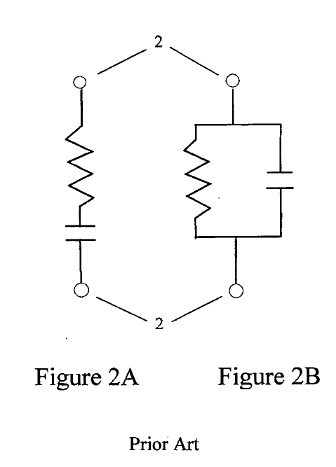

Attention is made now to FIGS. 2A and 2B, which illustrate alternative ways to choose the measured component the complex impedance between two electrodes in meat There is variety of well known methods to measure the components of complex impedance.

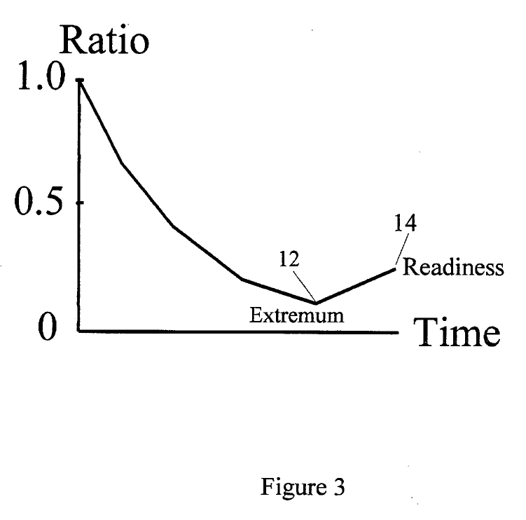

Attention is now made to FIG. 3, which is a schematic illustration of a preferable method of determining meat readiness according to some embodiments of the invention. Calculating unit 4 (not shown) may identify the meat readiness by calculating sequentially the ratio of each value of the impedance component to an initial measured value. In order to identify the meat readiness it is possible to check if said ratio has passed extrernum value 12 and reached readiness value 14 corresponding to the meat readiness. Extrernum value 12 of the ratio may indicate the point in process where the meat starts to lose liquids. There may be certain meat conditions or types where said ratio may not reach extrernum value 12. In these cases it is possible to determine the meat readiness by checking if said ratio has reached a certain predefined value corresponding to the specific meat.

1. An apparatus comprising:
at least two electrodes, said electrodes are insertable into meat;
a unit to measure sequentially values of at least one component or parameter of complex electrical impedance between said electrodes in certain frequency; and
a unit to store said measured values, to compare current momentary measured value of said impedance to a previously measured value of said impedance and to identify meat readiness according to predefined criteria of impedance based on said comparison.

2. The apparatus according to claim 1, wherein said electrodes are at least partially covered with insulating coating.

3. The apparatus according to claim 1, further comprising means to provide a readiness signal if said criteria are satisfied.

4. The apparatus according to claim 3, wherein indicating means is activated by said readiness signal.

5. The apparatus according to claim 3, wherein means to automatically stop the cooking when meat readiness is identified may be activated by said readiness signal.

6. The apparatus according to claim 1, further comprising means to adjust said criteria of impedance.

7. The apparatus of claim 1 wherein said previously measured value is an initial measured value.

8. A method comprising the steps of:
inserting at least two electrodes into meat;
measuring sequentially and storing values of at least one component or parameter of complex electrical impedance between said electrodes in certain frequency;
comparing current momentary measured value to the initial measured value; and,
identifying meat readiness according to criteria of impedance based on said comparison.

9. The method according to claim 8, further comprising the step of providing readiness signal if said criteria are satisfied.

10. The method according to claim 8, further comprising the step of predefining said criteria corresponding to the desired level of the meat readiness.

11. The method according to claim 8, further comprising the step of calculating the ratio of said current momentary measured value to the initial measured value.

12. The method according to claim 11, further comprising the step of checking if said ratio has reached value corresponding to the meat readiness.

13. The method according to claim 11, further comprising the step of checking if said ratio has passed the extreme value and reached value corresponding to the meat readiness.
